(19) United States
(12) Patent Application Publication
(10) Pub. No.: US 2005/0209893 A1
(43) Pub. Date: Sep. 22, 2005

(54) System and method for identifying and servicing medically uninsured persons

(76) Inventors: John Si Nahra, Plymouth, MI (US); Kevin Michael Juszczyk, Northville, MI (US); Randy Alan Stuck, Northville, MI (US); Lucille Smith, Northville, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/082,683

(22) Filed: Mar. 17, 2005

Related U.S. Application Data
(60) Provisional application No. 60/554,247, filed on Mar. 18, 2004.

(51) Int. Cl. G06F 17/60

(52) U.S. Cl. 705/4; 705/2

(57) ABSTRACT

A system for registering, tracking the medical process, and servicing persons who do not have healthcare insurance employs a central database available to healthcare providers, employers, and the public. The system provides a number of unique advantages to healthcare providers and employers to register their uninsured patients, employees and retirees and to individuals who voluntarily register. These benefits motivate the registration of uninsured persons into the system. The registration involves a consent form and a registration form which establishes the initial information for a patient in a central database. Each patient is assigned a unique identifier number and changes in healthcare status, treatment and the like are entered into the system to track the medical progress of uninsured persons who are registered. A variety of services such as specialist referrals, medical checkup reminders and the like maintain the system in active contact with all the registered uninsured.

### RELATED APPLICATION

This application claims priority of U.S. Provisional Patent Application Ser. No. 60/554,247 filed Mar. 18, 2004, which is incorporated herein by reference.

### FIELD OF THE INVENTION

This invention relates to a method for identifying and servicing medically uninsured persons and to a system embodying the method, including a central database identifying uninsured persons. Data relating to such persons is contributed from diverse sources.

### BACKGROUND OF THE INVENTION

According to Census Bureau figures, in 2002 15% of the U.S. population lacked any form of health coverage, public or private. These 44,000,000 Americans are referred to as the uninsured. In 2000 the number was 14% or 39,000,000 Americans. The growth in the number of uninsured Americans will undoubtedly continue into the foreseeable future. Despite the size of this population, the uninsured individual remains an anonymous entity to the healthcare system.

Every insured person is identified by and known to other parties in the healthcare system: an insurer, a health plan sponsor or a provider for example. Those with no coverage (the uninsured) face the healthcare system as an unknown without any history. Those who gain and then lose coverage (a majority of the uninsured) are invisible during their uninsured periods and have little or no coverage history to follow them should they regain coverage. An uninsured person may be known to a specific provider, but movement of uninsured persons from one provider to another goes largely undetected and unnoted by the health system.

These current realities have consequences in terms of excess costs, inefficiencies, and inequities. Public and private efforts have focused on specific problem areas, but these efforts have not addressed the actual identification of uninsured persons. Mandated identification via governmental fiat would likely be resisted as an attempt at imposing a national health insurance policy which Americans have consistently rejected for decades.

### SUMMARY OF THE INVENTION

The present invention is accordingly directed to a voluntary process of identifying the uninsured. Voluntary identification would be enhanced if endorsed by providers and/or employers. The service associated with the process of identifying the uninsured within the healthcare system is hereinafter referred to as the “Virtual Health Plan” (VHP) and the service specific to the employer segment for volunteer enrollment of employees and retirees as well as individual voluntary enrollment is referred to as the “Access Assistance Club” (AAC).

The method of the present invention involves the establishment of a central database identifying medically uninsured persons and including pertinent items, such as address information, medical records, treatment records, payment records, and the like. In general, this information is the same type of information that would be maintained in a database of medically insured persons. The information is provided to the central database by health service providers which perform services for the uninsured, from employers of the uninsured, and from the uninsured individuals themselves who are encouraged to register by mail or via a website, as a result of advertising programs, and the like. The database information is modified by the contributors as status is changed, services performed, etc.

The system and method of the present invention utilizes the information stored on the database as the foundation for a suite of medical service provider practice management tools that reduce provider administrative expenses and increase financial return from some portion of the uninsured patients they see. These tangible advantages for providers create the basis to encourage providers to identify the uninsured patients to the central database. The method of the present invention also allows employers of persons without health insurance an opportunity to improve employer relations and enhance job performance while reducing overhead costs associated with uninsured employees. Since a large majority of uninsured persons are employed, this encourages employers to assist in registration of their uninsured employees on the system.

The system allows interested employers an opportunity to improve employee relations and enhance job performance while reducing overhead costs associated with uninsured employees. These measurable benefits provide the basis for employers to embrace the idea of voluntarily identifying their uninsured employees since three-quarters of the number of uninsured persons are employed.

The system and method for the voluntary identification of the uninsured places them administratively on a par with insured persons, follows them across provider settings, and documents their changing relationships with the healthcare financing system.

The existing administrative process, schematically illustrated in FIG. 1, consists of a reactive set of procedures that vary across provider organizations and often vary within a provider organization. When a patient presents for care in an emergency room setting, 10, the provider is usually obligated by law to deliver service specific to the complaint, 12. Typically the provider establishes a medical record number for a patient when they initially present for care, 14, and establishes a case record, 16, and a billing record, 18. That number may or may not carry along with the patient during repeat visits to the same institution. Patients that indicate that they are unable to pay or do not have insurance coverage are screened to determine if the patient may be covered through the institution's charity care policy, 20. Experience has shown that the application of a charity care policy is sporadic, at best. Patients are also asked if they have an insurance card for any form of coverage, 22. If they do, the hospital investigates to see if the card is valid, 24. If the card is valid, the patient is processed in the normal manner, 26. If the patient is a charity case or does not have any other coverage, the hospital applies some policy that may or may not be uniformly enforced with self-pay patients, 28. In general, institutions do not uniformly enforce their payment policies; their follow-up procedure on verification of coverage is not standardized and is somewhat sporadic in nature. In many instances there is no validation process and patients are cast into a pay class that is often written off by the institution.

### BRIEF DESCRIPTION OF THE DRAWINGS

Other objects, advantages and applications of the present invention will be made apparent by the following detailed description of the preferred embodiment of the invention. The description makes reference to the accompanying drawings in which:

FIG. 1 is a flowchart illustrating the existing administrative process for dealing with medically uninsured persons by healthcare providers;

FIG. 2 is a schematic diagram illustrating the sources of registration of the uninsured in the database of the present invention;

FIG. 3 is a schematic diagram illustrating the process of entering registration data and service data into the database of the present invention;

FIG. 4 is a flowchart of the process used by an employer to register uninsured employees in the database of the present invention; and

FIG. 5 is a flowchart illustrating the process by which individuals without health insurance can self-register on the system of the present invention.

### DETAILED DESCRIPTION OF A PREFERRED EMBODIMENT OF THE INVENTION

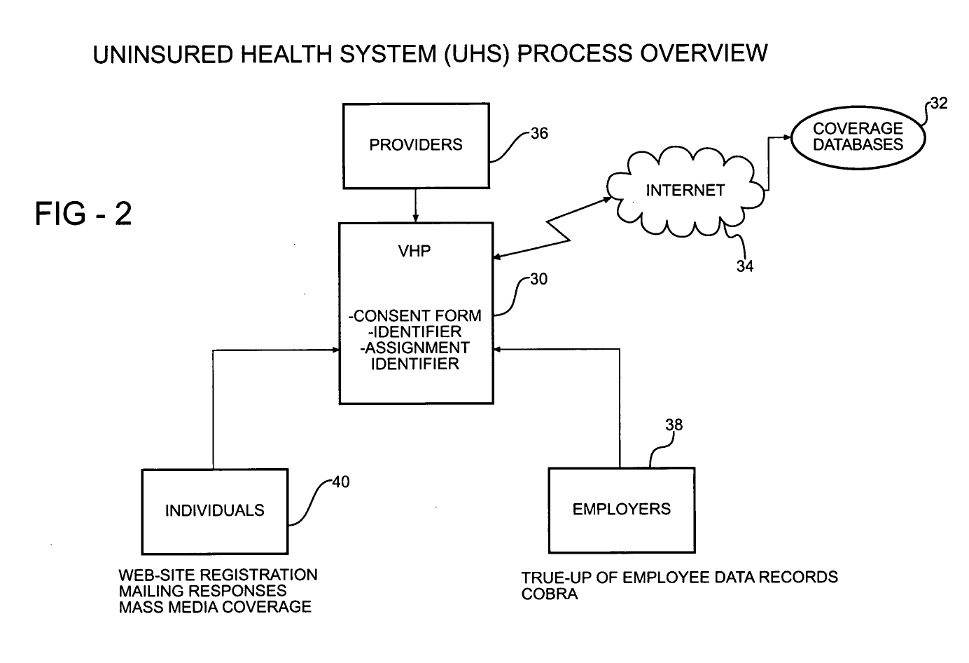

The registration process of the present invention starts with a unique method of registering an uninsured person, schematically illustrated in FIG. 2. The first step is to secure the approval of the registrant by having them read and agree to the terms of a consent form. By signing this form, the patient is agreeing to allow the system to use the patient's information to best deliver healthcare services. After the patient has given consent to the system to gather and use information on them, the intake process begins.

The first action taken by the VHP system 30, during the intake process, is to determine immediately if the person is already in the database. Patients may be registered into the system at one institution and tell another site that they are not registered. This needs to be verified before the intake process begins. Coverage also needs to be ascertained before the intake process begins. With a minimal amount of information, such as a name and date of birth, the VHP system can query coverage databases, such as Medicaid, Blue Cross Blue Shield plans, commercial health payers and other online sources 32 to determine if there is any current coverage on each individual using a communication system such as the Internet 34. If the person is covered, existing processes for billing and payment occur. If the system indicates that the person does not have any form of coverage, then a full intake routine begins. Information on the uninsured person is electronically fed into the system database through an onscreen form where the fields of information are input from healthcare workers at various sites such as hospitals, clinics, and physicians 36, input from employers 38, and input from surveys or online application forms that are completed by the uninsured themselves 40 in written form or through an interactive voice response session. The registration form is preferably an electronic input form available on the Internet and accessible over a secure interface that is password protected. At the time of registration, each registrant is provided a unique ten-digit identifier number that is automatically generated by the SQL database program and placed on the consent form. This number is held in a relational database (SQL) within the VHP system 30 and associated with a wide variety of identifiers such as social security number or medical record number, as well as characteristics on each individual, such as changes to coverage, medical history, eligibility status, risk factors, treatment regimens and so on, all derived from the registration form and subsequent information provided to the database within the system 30.

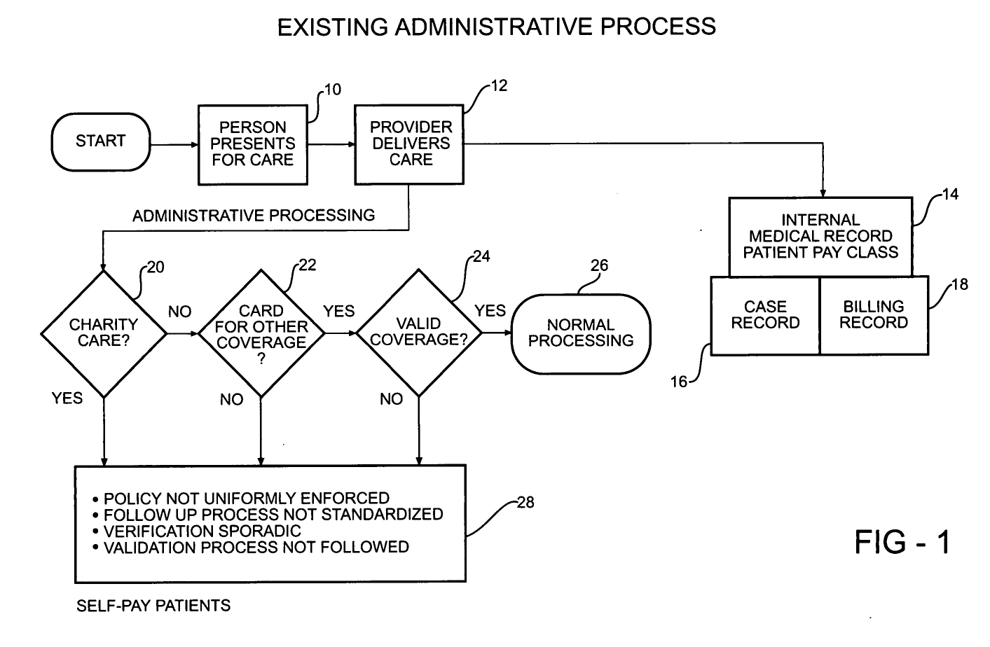

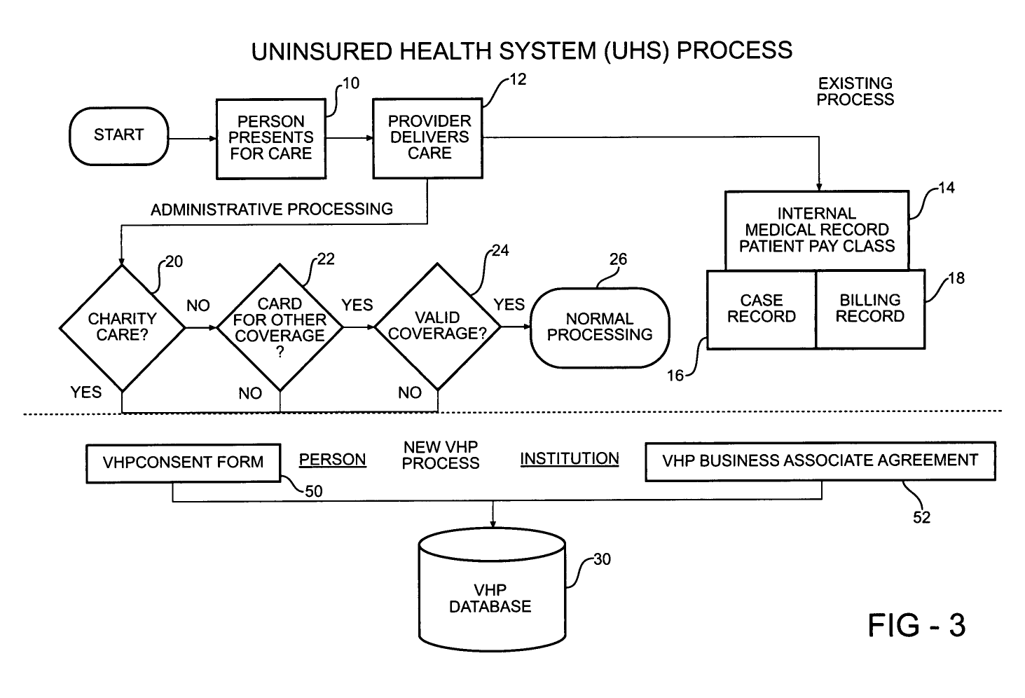

FIG. 3 schematically illustrates the relationship between the existing administrative process, essentially as disclosed in connection with FIG. 1, and the VHP process, built around the VHP database 30. A patient being registered into the VHP system by a provider is asked to execute a consent form, at 50. Then the registration date is provided to the database 30 and is first verified, then an identifier is provided. A determination is made as to whether there is coverage by other insurers and the information from the registration form is then fed into the database 30. A healthcare provider seeking to do business with the VHP system executes a business associate agreement at 52, and that date is also entered into the database 30.

During the registration process, the system 30 can verify the accuracy of the information being provided by the patient. Addresses can be automatically verified, for example, and information, such as estimated household income, can be used to quickly determine if the patient may qualify for inclusion in a specific charity care program at an institution. Patients that do not qualify for full write off of their medical expenses may qualify for a discounted service rate that can be automatically calculated by the VHP system and an appropriate fee assessed to the patient.

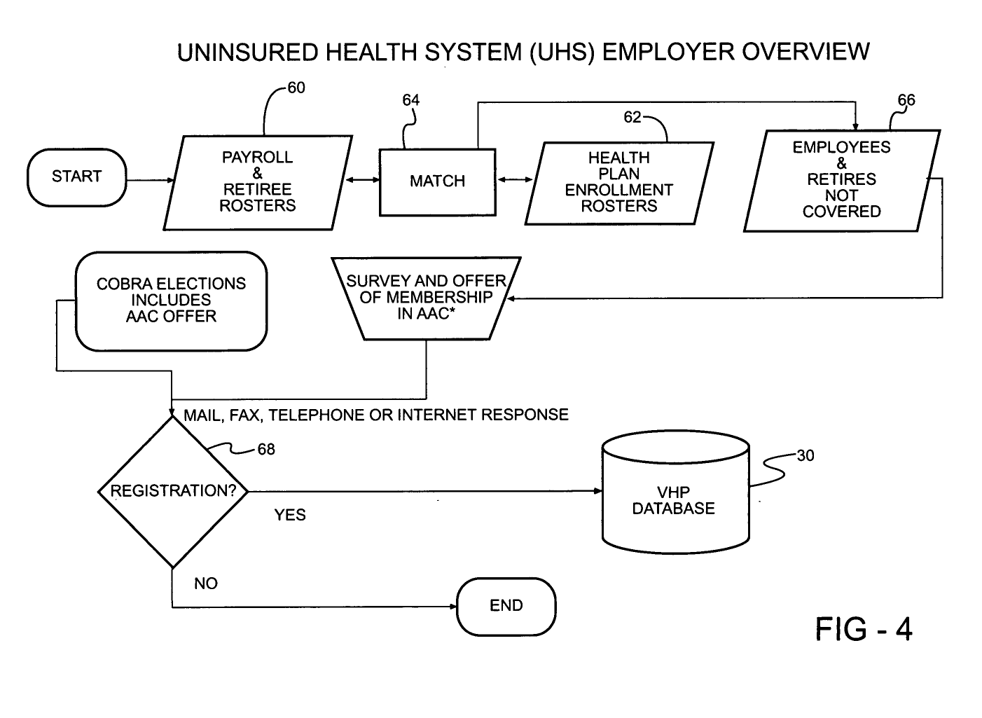

The process involved in an employer 38 providing information from its uninsured employees for incorporation in the VHP system is illustrated in FIG. 4. The payroll and retiree rosters 60 of the employer are compared to the roster of the employees covered by the company health plan or plans at 62 and the resultant list of uninsured payroll and retired employees is provided by box 64 to a database 66. The uninsured employees and retirees are offered membership in an Access Assistance Club (AAC) that includes registration in the VHP system 30. Those who accept and fill out the registration forms which are provided to the VHP system at box 68 and the data is put into the VHP database.

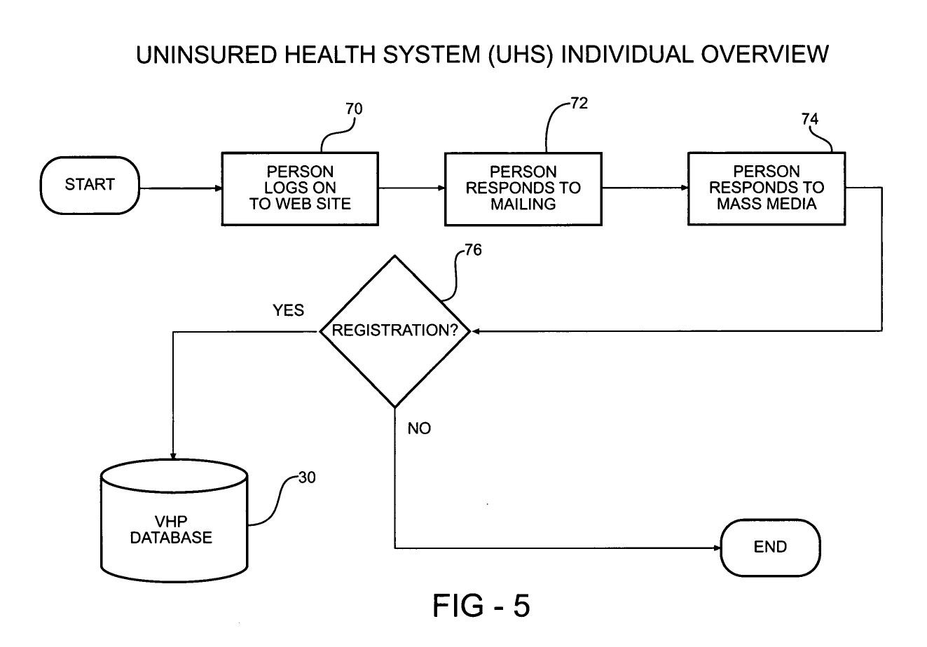

The process used by an uninsured individual to obtain the advantages of the VHP system is schematically illustrated in FIG. 5. Individuals are solicited through the VHP system's website 70 through direct mailings 72, through ads in the mass media 74, or other means. If they indicate that they are seeking registration, at block 76, they execute a consent form and the registration form, and that information is provided to the VHP database 30. They are then treated in the same manner as an uninsured patient submitted by healthcare providers or employers.

After an uninsured person is registered in the VHP system, the system can help manage some of the health risk issues by utilizing information in the health system database 30 in conjunction with an intelligent interactive voice response program designed to reach out to people to remind them to continue to comply with their treatment regimen, survey people to determine their health status (or gain other valuable data), remind people of scheduled appointments or arrange public or private transportation services, and connect people to healthcare specialists automatically when conditions warrant. The automated voice interface linking the system to a person under medical care is handled using the voice of the physician responsible for that person's care. In addition, an email note can be sent that alerts the care management personnel at an institution to call the patient that may be at high risk and help that patient navigate through the health system to ensure best delivery of care to manage their specific condition. This email notice can be automatically sent on a daily basis to notify care management personnel.

Through a screening module of the VHP system, patients can be automatically screened to determine if they may be eligible for state, federal or local programs that may be specific to their individual healthcare needs and circumstances.

Patients that require follow-up care with a healthcare specialist, such as a cardiologist or podiatrist for example, can be referred to a specialist through an automated interface. The VHP system is designed to accommodate a pooled resource of specialists that can be readily accessed by primary care providers on behalf of their patient. The primary care provider selects the type of specialty they need for their patient and then places a request through the VHP system for an appointment. Once the appointment is secured, the VHP system prints out a referral form for the patient that includes the name and directions to the specialist. Follow-up administrative processes have also been designed into the user interface for input of treatment and diagnostic codes and for the scheduling of additional appointments.

Service record information can be automatically sent on a daily basis by the healthcare institutions so that delivery of care to the uninsured can be properly and efficiently documented and a valuation placed on services. The transmission of the service records from the institutions to VHP can be handled in various ways. The most efficient method is to process the patient record in the same manner as any other patient record and treat the VHP as if it were a “third party payer” that receives daily submittals of claims or billing records for processing. In this instance of sending a billing record, however, there is no expectation of payment from the VHP. This process merely serves as a mechanism to have the diagnostic and treatment information electronically sent to VHP in a very efficient manner.

The data may also be sent as a batch file on a scheduled basis. This is more costly to the provider and usually involves some manual work to prepare and transmit the file each month.

For the individual provider, there is a web interface that allows personnel in the provider-billing department to enter the appropriate diagnostic and treatment codes into an online form comparable to forms commonly used for claims submittal.

In addition, the VHP system 30 will accept periodic write-off files from institutions to determine possible coverage on patients that may have been missed by the institutions' own review processes. The write-off file is analyzed for possible Medicaid and other coverage and also to determine potential recoveries related to injury cases where liability coverage through unknown third parties may exist and where collection activity may produce significant financial results for the institution.

The VHP system 30 is also capable of supporting the needs of an institution in rendering billings for self-pay patients that are covered under charity care policies of an institution.

From an employer perspective the uninsured or self-pay worker represents an additional liability with respect to their potential absence from work or potential productivity level that may be impacted by healthcare needs. National studies have shown that the uninsured use the health system far less than the insured and typically wait until a health issue is truly pressing before they seek treatment. The result is that the health condition of the uninsured has deteriorated to a far greater degree than necessary before they seek treatment. This is more costly to the individual in terms of potential recovery cycle and to the employer in terms of lost productivity since the absence is far longer than might be if the condition had been addressed early. In an effort to combat this issue, the VHP system offers employers the opportunity to identify their uninsured employees by engaging the VHP system to conduct a review and analysis of the employer's payroll and retiree rosters and match the data with the health plan enrollment rosters. The resulting output will produce a list of employees that potentially are not covered. The VHP system, at the behest of the employer, will send out a survey to these employees to offer membership in the Access Assistance Club (AAC) that provides some form of access to healthcare that coincides with their ability to participate financially. The AAC will also work with employers to include a notice of offer for membership in the AAC when COBRA notices are sent. Employees can respond to the membership notice by return mail, by a telephone response or over the Internet.

The AAC is also available to the general public through an Internet interface. An interested registrant can log in the AAC website, respond to a mailing or respond to a mass media outreach to register in the AAC program. The program offers assistance in gaining access to healthcare, helps with management of referrals to specialists, screens applicants for potential inclusion in public and private programs, automatically conducts a health risk assessment through a data form, supports follow-up care and treatment programs, works with patients requesting assistance in handling medical payments, processes qualified requests for medical lines of credit, and handles other related administrative activities.

The process that has been developed to reduce the repetitive and improper use of emergency room resources involves the assignment of each new registrant to a medical home as their primary care provider site. Each registrant is given a unique ten-digit identification number by the VHP system 30. Usage by each registrant through their patient service records is tracked and entered into a single database. This database is an SQL database, and individual information on enrollees is available through a secure Internet link that is password protected and requires an individually assigned ID to gain access. The medical claim history for all the participating healthcare providers also resides in the same database.

The system of the present invention employs viable procedures that effectively document the cost of care for the uninsured by standardizing the handling and administration of the uninsured across multiple provider types, environments, technologies and locations. In addition, it incorporates means to electronically manage patient data from disparate systems by establishing a universal web-based application. This technology can be integrated into existing registration environments to provide a seamless single entry of patient data. Separate software modules handle: (1) enrollment verification; (2) medical home assignment determination; (3) initial registration and health risk assessment; (4) patient referrals (specialist referrals); (5) patient treatment history inquiries; (6) specialist treatment outcomes; (7) other coverage queries and claim submittals; (8) address and income verification; (9) home ownership or rental status; (10) automatic charity care policy rating procedure; and (11) automated high volume coverage review and daily results reporting.

The following description details the processes that are employed to establish a viable environment. The first section deals with gaining concurrence for technical connectivity between the various health systems. The second section deals with identifying the resources necessary to support the needs of the uninsured. The third section deals with the economic viability of engaging the participating providers in using their existing technology, existing administrative methods and electronic processes in conjunction with the universal technology of the present invention to make it easier for all involved to administer the uninsured. The system allows each healthcare system, provider and physician to administratively handle the uninsured in a manner that is very similar to that used for the insured person and to streamline what has been a manual process to reduce the provider's overall expenses and deliver greater quality of care to the uninsured.

The present invention provides a technical solution that:
1. streamlines the existing administrative functions;
2. reduces the occurrence of overuse and abuse of the healthcare system;
3. enhances the quality of care management;
4. integrates online information;
5. coordinates the delivery of healthcare between the participating providers;
6. ensures the system supports provider-centric care; and
7. provides an additional source of funding.
   1. Streamlines the Existing Administrative Functions:

The electronic system 30 is a secure web-based application that presents a password-protected method to access information on the uninsured. Through this web-based application there is a module that presents a form where the provider can enter a name and date of birth or patient ID number to determine if a patient is currently registered in the system and in which medical home the patient resides. (Each patient is assigned to a medical home based on where the patient is initially enrolled.) If the patient is not enrolled, the web-based system presents an enrollment form. By simply following the form and entering in data in each field as requested on the screen, a patient can be enrolled in the system. The system automatically generates a patient ID number and prompts the intake person to assign the registrant to the appropriate medical home. A list of medical homes that are specific to the intake site is presented to the intake person for selection and assignment. During the intake process, each patient is asked a series of questions as part of a health-risk assessment. For report purposes the patient information from the health-risk appraisal is de-identified and maintained in a separate secure database in full compliance with federal privacy and security standards.

In addition, the system also presents a screen for primary care providers to refer patients to specialists. The form that is presented for patient referrals is health system specific and each provider must use their own password and ID to use the referral system. After logging in to the system for a referral, the primary care provider (PCP) identifies the type of specialist they are requesting and the patient ID information. The system automatically polls the database of existing specialists and assigns the referral to a specialist that is next in line for a referral. The system paints the screen at the primary care provider's office with all the contact information on the specialist so that an appointment can be made. The PCP office calls the specialist's office, arranges an appointment for the patient and enters the appointment time onto the referral screen. Once the appointment is made with the specialist, the primary care provider's office submits the data and prints out a referral slip for the patient to take with them to their appointment. The referral slip is given to the patient and has the name and location of the specialist plus the appointment date and contact information (office telephone number).

2. Reduces the Occurrence of Overuse and Abuse of the Healthcare System:

Enrollment Verification—One of the prime elements of the process is the assignment of patients to a medical home. Some portion of the uninsured patient population migrates from one health system to another for their healthcare needs. As a result, there can be a significant cost to each system for duplication of tests, diagnosis and procedures that can be avoided if a patient remains within one medical home. In an effort to lessen the occurrence of these migrations, the universal data system of the present invention offers an easy method for each site to determine the correct medical home for each patient that presents for care and potentially avoid duplication of tests.

Medical Home “Push-Back”—When patients present themselves for care, the present system offers the means for treatment centers to determine if the patient, indeed, really belongs to them. If the patient has decided to migrate to another healthcare system for treatment, the system can be used to identify that the patient is: (1) already registered, and (2) which institution has taken responsibility for ongoing care of the patient and where the medical home is for the patient so the patient can be referred back for care.

Public and Private Payer Inquiry—Through Electronic Data Interchange agreements with both public and private payer groups, the system can quickly ascertain if a patient that presents for care as an uninsured patient is actually eligible for coverage. The system is electronically linked with the major payer groups as well as Friend of the Court databases for documenting other available coverage.

Death Notice Inquiry—The system is electronically linked with the system that supports the county morgue to conduct a query to identify persons that have died and should be removed from the active list.

Alternate Program Eligibility Inquiry—There are certain conditions that receive special funding and dedicated resources. The system is designed to help identify these special cases and conduct automated inquiries on behalf of the patient to seek enrollment in these alternate programs.

3. Enhances the Quality of Care Management:

On-Line Health Risk Assessment—The enrollment process that has been established involves the use of a Health Risk Assessment form that exists in an electronic format. The Health Risk Assessment (or Appraisal) form is used at the time of enrollment to ask a series of health practice questions to determine the lifestyle of the enrollee and the risk the patient presents in terms of healthcare needs. A smoker, for example, poses much greater risk of needing care than someone who does not smoke and may be at risk for asthma, lung disease and other related illnesses. Information entered on the Health Risk Assessment form may trigger specific outreach processes.

Integrated Service Record History—The present system benefits from a history of patient services. This is accommodated through a detailed report that provides information for services received within a health system and a non-detailed report for services a patient received from outside of a particular health system. In this fashion, someone from one health system, for example, may make some modest determination of the patient history on an emergency patient from another health system that presents for care at an emergency center.

Baseline-Driven Outreach Program—Studies have shown that considerable savings can be achieved through preventive care and patient intervention. The system 30 provides an automated interface whereby patients will be contacted by telephone and hear the familiar voice of their primary care provider. The automated system uses baseline measures to determine from patient feedback if their responses are far enough off to warrant real-time communication with a healthcare professional. If so, the system will automatically transfer the patient to a live healthcare professional for assistance.

Automated Patient Feedback (Quality Control)—Using an interactive voice response system for patient follow up is a very cost-effective method of securing patient response to quality control questions. The data gathered from the respondents is automatically entered into the database and results are automatically generated for online viewing and analysis.

Medication Compliance Monitoring—Another use for interactive voice response technology involves outbound calls to patients that have been identified as high risk patients for potential emergency room events. Using the central UHS database, the system can identify asthma patients, diabetic patients and others that need to maintain medication regimens. The system calls these patients and, preferably in the voice of their own physician, reminds the patient to take their medications. The system also engages in an interactive dialog to determine the patient's needs, to moderate the process of modifying treatment and secure live intervention on behalf of the patient when warranted.

Track and Maintain Standards—Some existing patient monitoring systems determine when patients need certain immunizations. The intent is to provide children, for example, with their immunizations at the time they present themselves for care at one of the clinic sites. Manually connecting with these patients is costly and time consuming, and the present system automates the process through an interactive voice response system designed to reach this patient population for such things as mammograms and other follow-up care.

4. Integrates Online Information:

Uninsured Patient Registration Process—The process provides the means to either directly register a patient online or to use existing processes that reside within a healthcare provider group. The UHS online system offers an electronic version of the patient enrollment form and the health risk assessment form. The intake person can use this interface if that is most convenient to their process or the intake person can continue to use any existing data interface. In the situation where the intake process is already available through electronic media the data is merely sent to the central database through a simple electronic file transfer (FTP) process. The central database serves as a repository-in-common for all data on the uninsured that includes the patient enrollment information, specialist referrals and service records. All records are available in some degree to all participants in the system to help manage the information on patients without concern for where they present themselves for care. Medical Home data is available on all patients on a real-time online manner so that patients can be referred back to their proper medical home.

Automated Physician Referral and Assignment—The system is designed to handle automated referral of patients to specialists. The specialist information is entered into the database whenever a specialist signs up to donate some of their time and resources. The amount of care being donated is recorded along with other pertinent data on the specialist. Each specialist's time is allocated based on an algorithm that ensures an even distribution of demand against availability. This ensures that no one physician or practice gets the bulk of referrals on demand for a particular specialty type.

Patient Service Billing Records—Connectivity exists with healthcare providers to electronically pass patient service records for inclusion in the central database, preferably employing the Internet. The automated process preferably involves handling their billings for uninsured in the same manner as the insured. The process sends billings to the VHP of the invention by treating the VHP as a third-party administrator. However, there is no expectation of payment on the bills being sent to the VHP on the uninsured.

Cost Trending and Budget Projection—Based on the data that is gathered on the uninsured, each of the health systems can more accurately predict their cost trends and budget their resources based on historic projections. The data for this purpose is made available in a de-identified fashion that is aggregated by the present system and also made available as system-wide totals.

Usage Trending and Resource Projection—The type of care delivered, the resources used and other relevant data generated by the system is provided to connected health systems to allow them to accurately predict what type of treatment will be needed and the resource requirements to meet the treatment demand. This information is made available to each of the health systems as a custom report or, alternatively, as raw data in a comma delimited ASCII file.

Intervention Tracking and Results Tracking—The system uses preventative measures to intervene on behalf of the patient to remind them to stay med-compliant and continue with their treatment regimens. This can significantly reduce the overall cost of patient care. Tracking the results of this effort and assessing a viable value to the avoidance of potential cost can be accomplished through the present system. Using a before and after view and having a control group for baseline measure will help ensure that the results for this portion of the research effort are credible.

5. Coordinates the Delivery of Healthcare Between the Participating Providers:

Enrollment Before Service—One of the key benefits of the universal data program of the present invention is the ability to make sure that each uninsured patient is properly enrolled before they receive treatment. Historically, health systems have focused their data gathering effort on the insured population since that group represents the likelihood of payment for services rendered. The uninsured populations have historically gone unrecognized and individual information on the uninsured does not reside in the myriad number of databases that exist for the insured population. Using the universal UHS package, the registration information on the patient is available to any of the participating health systems through immediate online access over a secure Internet connection.

Uninsured Service Record History—Through agreements with healthcare providers associated with the system, all service records are sent by providers to the VHP for processing. A complete treatment history on individual patients is available for a requesting physician to review. Trending reports on de-identified data are also available for review by physicians as an aid to determining health trends and treatment responses based on historical data.

Responsive Outreach Program for Preventive Care—Based on the data collected by the system, certain preventive measures will be taken to intervene on behalf of the patient. Through an outreach program, patients will be contacted by telephone, by pager, by fax and by email to help the patient remain compliant with their treatment program. Through interactive telephone sessions with patients, ongoing data will be expanded upon to gain greater insights into behavioral trends on preventive care.

Non-proprietary Systems Environment—The system provides universal non-proprietary access to web-based programs through a password protected user interface. Each of the associated healthcare systems can download raw data for their own internal manipulation and view custom reports available online.

6. Ensures the System Supports Provider-Centric Care (Sheet #3):

User Interface Custom To Provider Group—Each healthcare provider group associated with the system has its own customized user interface designed to meet the specific needs of that group. The system is designed to mechanize some of the existing manual processes and streamline these processes in an efficient manner. In order to accomplish procedural efficiencies it is necessary to understand the parochial workflow of each of the participating groups and accommodate these needs in the user interface.

Database Specific To Provider Group—The system 30 uses a Sequential Query Language (SQL) database which is a relational database. Various tables have been constructed to serve as individual repositories for provider specific data. The information is housed as one cohesive database and information on one provider group is not shared with other provider groups.

Medical Home Identifier In-Common—Patient medical home data is shared in common to ensure that the medical home of the patient can be identified wherever the patient presents themselves for care.

Provider-Specific Processes Supported—The system design accommodates the individual needs of each of the provider groups and their own unique processes. If, for example, a provider group wishes to have the system accommodate their need for referrals to specialists, the system can address that need. Should a provider group need to support a particular charity care policy, the technology meets that need.

Universal Specialist Referral Process—In the standard model, physicians will be seeing patients that come from anywhere in the area. In other environments the focus of resources may be limited to a specific county. In the typical health system environment, patients from outside of the local county will also be seen and information gathered into the database for referral administration. Information on specialists is placed into a universal database within the system and through an assignment algorithm patients will be assigned for care on a rotation that evenly spreads the demand among specialists based on specialty type.

Universal Database—The SQL database is universal in composition and houses information on uninsured patients, underinsured patients, insured patients. The database will also contain demographic information, contact information, health risk assessment information and service data as well as preventive care response data and other relevant data for private and public payer communication for eligibility and status inquiries.

1. A system for registering, tracking and providing services to persons who do not have medical insurance coverage comprising:
a central database storing a number of uninsured persons along with their personal identification, medical history, and assigned identifier;
providing healthcare providers, employers, and uninsured individuals with access to a registration form for use in connection with said database;
providing means of communication between healthcare providers, employers and uninsured individuals with the central database; and
making the information on the database available to at least certain healthcare providers, employers and uninsured individuals.

2. The system of claim 1 including means for providing information from the central database to the certain healthcare providers, employers and uninsured individuals.

3. The method of identifying medically uninsured persons, comprising:
establishing a database;
soliciting uninsured persons to fill out a registration form;
listing the identification and relevant information from the registration form on the database; soliciting changes to the registration information;
modifying the information stored on the database to reflect such changes; and
making information stored on the database available to selected entities.

4. The method of claim 3 wherein the step of soliciting uninsured persons to fill out a registration form comprises soliciting registration of uninsured persons from healthcare providers, employers of uninsured persons, and uninsured persons themselves.

5. The method of claim 3 wherein the step of listing the identification and relevant information from the registration form on the database utilizes a public network such as the Internet.

6. The method of claim 5 wherein the step of making the information stored on the database available to selected entities comprises use of a public network such as the Internet.

7. The method of claim 3 including the step of assigning a unique identifier to each uninsured person listed on the database and communicating such unique identifiers to healthcare providers for and employers of such uninsured persons.

8. The method of claim 3 wherein the registration form includes the uninsured's name, contact information for the uninsured, and the medical history of the uninsured.

9. The method of claim 3 wherein the step of soliciting uninsured persons to fill out a registration form comprises mass media and direct marketing.

10. The method of claim 3 wherein the step of making information stored in the database available to selected entities comprises making information available relative to the provision of healthcare services to registered persons.

11. A system for providing a registry of medical uninsured persons, comprising:
eliciting healthcare providers who perform medical services for uninsured persons to fill out a registration form;
soliciting employers of medically uninsured persons to cause the persons to fill out the registration form;
establishing a central database;
extracting information from the registration forms of medically uninsured persons including such information on the database along with a unique identifier for each uninsured person; and
making information stored on the database available to selected entities through public communications networks.

12. The system of claim 11 further including offering services to medically uninsured persons registered on the database.

13. The system of claim 12 wherein the services include contacting the uninsured persons to advise them of healthcare appointments.

14. The system of claim 12 wherein the services include establishing medical specialist appointments for the uninsured.

15. The system of claim 12 wherein the services include transmitting reminders to medically uninsured persons registered on the database to perform healthcare-associated tasks.

16. The system of claim 12 further including maintaining a record of medical service provision to registered medically uninsured persons on the database.

17. The system of claim 11 wherein the step of listing the identification and relevant information from the registration form on the database includes sending queries to healthcare payers to determine coverage for such uninsured persons.
